(19) United States
(12) Patent Application Publication
(10) Pub. No.: US 2026/0181009 A1
(43) Pub. Date: Jun. 25, 2026

(54) CYBERSECURITY WORK STREAM DEPLOYMENT AND REPORTING

(71) Applicant: T-Mobile USA, Inc., Bellevue, WA (US)

(72) Inventors: Raghavendra Kulkarni, Sammamish, WA (US); Sudhanshu Pandey, Sammamish, WA (US)

(21) Appl. No.: 18/990,767

(22) Filed: Dec. 20, 2024

(51) Int. Cl. H04L 9/40; H04L 41/16

(52) U.S. Cl. CPC H04L 63/1433; H04L 41/16; H04L 63/20

(57) ABSTRACT

Described herein are one or more computing devices retrieving a list of telecommunications network assets and corresponding Internet protocol (IP) addresses, defining a list of cybersecurity work streams to be performed by the telecommunications network assets, and, responsive to a single user input, deploying the list of cybersecurity work streams to the subset of telecommunications network assets. The one or more computing devices further retrieve status from telecommunications network assets for the cybersecurity work streams, determine asset owners for the telecommunications network assets based on the corresponding IP addresses of the telecommunications network assets, and provide a report to the asset owners of cybersecurity work stream results.

### BACKGROUND

Identifying ownership of assets (e.g., computing devices, user equipment) in telecommunications networks is critical for vulnerability remediation and compliance with cybersecurity policy. Such asset owners—those responsible for ensuring remediation and compliance of the assets that they owner—must be manually identified in a database with thousands or even millions of assets. Even with a diligent team working to keep this information up-to-date, there may need to be frequent ownership changes to many assets (as they are identified by Internet Protocol (IP) addresses, which often change). This in turn may result in gaps for deploying cybersecurity work streams—which is also a manual, time intensive process, with each work stream deployed individually—and gaps in reporting. An owner or owner's supervisor, trying to ascertain degree of compliance, may have a difficult time pulling together the needed information.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIGS. 1A-1B show overview diagrams of asset owners faced with manual entry and retrieval of cybersecurity information (FIG. 1A) and of asset owners with asset ownership autopopulated, reported, and used for multi-work stream cybersecurity deployment (FIG. 1B).

FIG. 2 is a network architecture diagram showing a subset of components and operations involved in claiming a subnet of IP addresses for an asset owner and using that subnet claim to autopopulate ownership information in an asset management database.

FIG. 3 is a network architecture diagram showing a subset of components involved in defining a list of cybersecurity work streams for specified telecommunications network assets and, responsive to a single user input, deploying the list of cybersecurity work streams.

FIG. 4 is a network architecture diagram showing a subset of components involved in retrieving status information from telecommunications network assets for cybersecurity work streams, determining asset owners for the telecommunications network assets, and providing a report of cybersecurity work stream results to the asset owners or supervisors of asset owners.

FIG. 5 is an example graphic user interface for a report of asset performance and cybersecurity work stream performance for asset owners and their supervisors.

FIG. 6 is a flow diagram of an illustrative process for receiving information for an asset, the information including an Internet protocol (IP) address of the asset, updating the asset database based on the information for the asset, and, based on a subnet associated with the IP address, automatically populating an asset owner for the asset in the asset database.

FIG. 7 is a flow diagram of an illustrative process for defining a list of cybersecurity work streams for specified telecommunications network assets and, responsive to a single user input, deploying the list of cybersecurity work streams.

FIG. 8 is a flow diagram of an illustrative process for retrieving status information from telecommunications network assets for cybersecurity work streams, determining asset owners for the telecommunications network assets, and providing a report of cybersecurity work stream results to the asset owners or supervisors of asset owners.

FIG. 9 is a schematic diagram of a computing device capable of implementing functionality of at least one of the components illustrated in FIGS. 2-4.

### DETAILED DESCRIPTION

This disclosure is directed in part to receiving, by a computing device, information for an asset, the information including an Internet protocol (IP) address of the asset. The computing device then updates the asset database based on the information for the asset. Based on a subnet associated with the IP address, the computing device automatically populates (or “autopopulates”) an asset owner for the asset in the asset database. Configuration information available to the computing device associates the subnet with the asset owner.

In various implementations, the disclosure also or instead includes retrieving, by a computing device, a list of telecommunications network assets and corresponding IP addresses. The computing device also defines (or enables a user to define) a list of cybersecurity work streams to be performed by the telecommunications network assets. Responsive to a single user input, the computing device deploys the list of cybersecurity work streams to the subset of telecommunications network assets. The computing device further retrieves status from telecommunications network assets for the cybersecurity work streams, determines asset owners for the telecommunications network assets based on the corresponding IP addresses of the telecommunications network assets, and provides a report to the asset owners of cybersecurity work stream results.

As used herein, an “asset” is any sort of computing device connected to a specific network (e.g., a lab network or test network of a telecommunications network operator), such as a laptop, a tablet, or a user equipment (UE). “Telecommunications network asset” is used interchangeably herein with “asset.” An “asset owner” is a designated person responsible for the state of one or more assets. The asset owner may be a user of the asset(s) or a supervisor (direct or indirect) of user(s) of asset(s). A “cybersecurity work stream” is a set of cybersecurity operations defined in, e.g., an Ansible playbook.

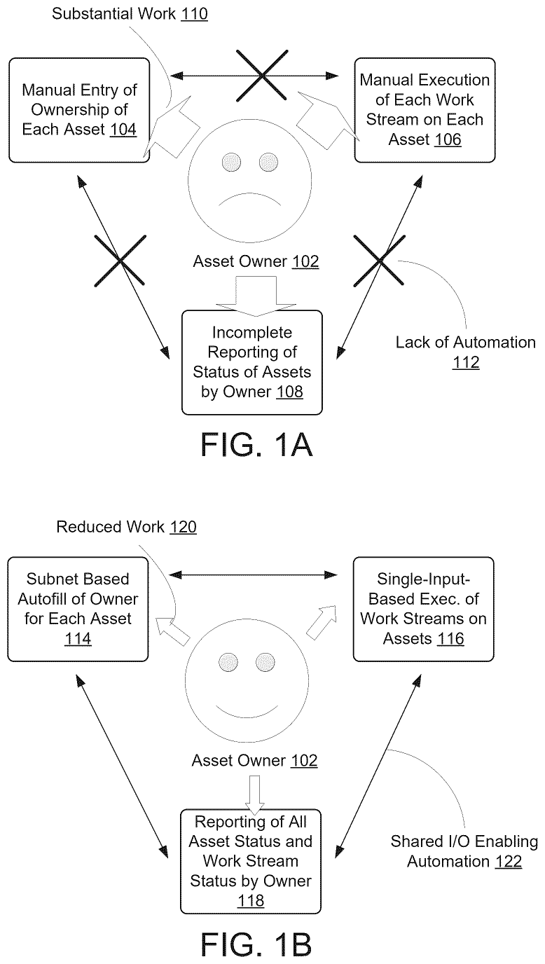

FIGS. 1A-1B show overview diagrams of asset owners faced with manual entry and retrieval of cybersecurity information (FIG. 1A) and of asset owners with asset ownership autopopulated, reported, and used for multi-work stream cybersecurity deployment (FIG. 1B). As illustrated in FIG. 1A, an asset owner 102 may need to, at 104, manually enter their ownership of each asset they own in an asset management database. The asset owner 102 may also need to, at 106, manually configure and execute/deploy each of a set of work streams (e.g., cybersecurity work streams) on each asset of a set of assets. Further, the asset owner 102 may receive incomplete reporting of asset status, at 108. The result, shown by the thicker arrows between the asset owner 102 and the operations 104-108 and by the frown on the face representing the asset owner 102, is a substantial amount of work 110 for the asset owner 102 or for someone performing that work on behalf of the asset owner. Further, much of this work may be repetitive and needlessly manual due to, e.g., a lack of automation 112 (shown in FIG. 1A by X-ed out arrows among the operations 104-108.

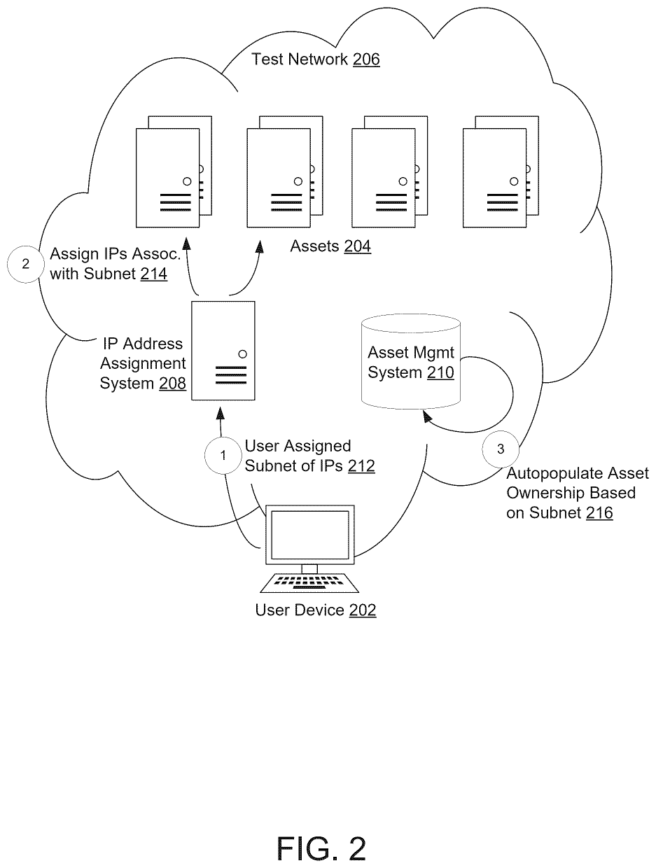

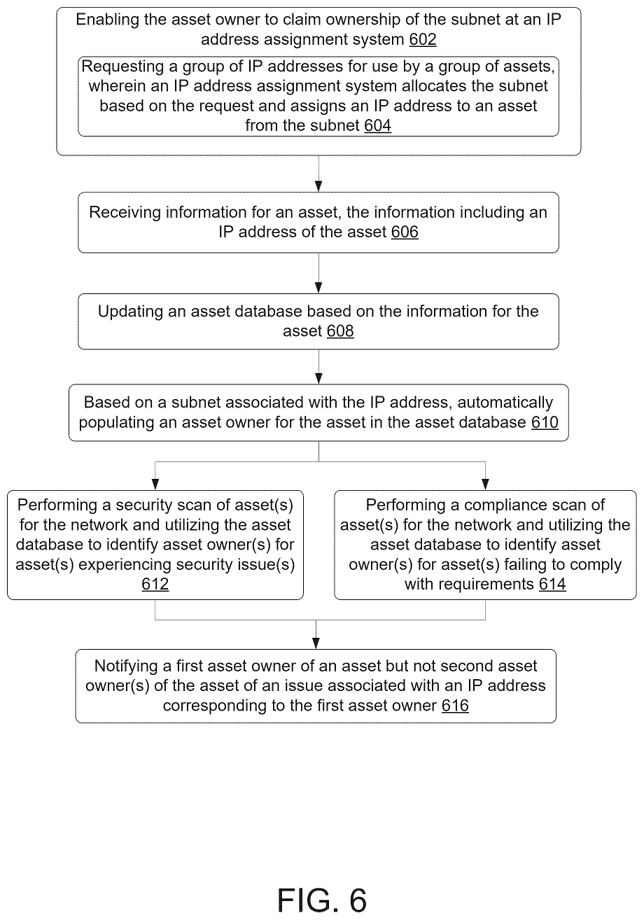

FIG. 1B illustrates asset owner 102 achieving different results. At 114, the asset owner 102 has their ownership of their assets automatically populated into an asset management database. This is achieved by having the asset owner 102 claim specific subnet(s) of IP addresses for their assets and by having the asset management database use those subnet claims and matches of subnets to IP addresses of assets to determine asset ownership. FIGS. 2 and 6 and their descriptions herein show and describe components and operations resulting in operation 114.

At 116, a computing device of the asset owner 102 performs a single-input-based execution of work streams (e.g., cybersecurity work streams) on the assets of the asset owner 102. The work streams may be defined in an Ansible playbook, with the asset owner 102 or other user having the ability to add to/edit the playbook (e.g., changing the order or work streams), and another file may list the IP addresses or domain names of the assets of the asset owner 102. In some implementations, this list of assets may also be edited. Logic of the computing device may then associate one or more playbooks with the list of assets for execution and, upon a single input from asset owner 102 or other user, may deploy the work streams of the playbook(s) to the assets for execution. Such a “single input” may be any sort of input, such as a “click” of a graphical user interface button/control, an image capture, a voice command, a touch/biometric, etc.

At 118, a computing device of the asset owner 102 reports all asset status and work stream status by asset owner. Such a report may be for a single asset owner 102 or for multiple asset owners, including asset owner 102. It may include a status window listing asset owners and, for each asset owner, a count of assets meeting a standard and a count of assets not meeting a standard (e.g., assets that have executed all work streams and those that have not). Also or instead, it may include a status window listing cybersecurity work streams and, for each cybersecurity work stream, a count of assets meeting a standard and a count of assets not meeting a standard. Further, it may include a details window listing each combination of an asset owner and cybersecurity work stream and, for each combination, an indication of whether or not the combination is meeting a standard. In some implementations, the report may also enable the asset owner 102 or other user to create or revise a list of work streams to be performed on assets, or to recommend work stream(s).

The results of operations 114-118 are reduced workload 120 for the asset owner 102 or other user—shown in FIG. 1B by thinner arrows between the representation of the asset owner 102 and the operations 114-118 and by the smile on the face representing the asset owner 102. The shared inputs and outputs—e.g., automatically populated asset ownership information—among the component(s) performing the operations 114-118 enables the automation 122 that results in the reduced workload 120.

FIG. 2 is a network architecture diagram showing a subset of components and operations involved in claiming a subnet of IP addresses for an asset owner and using that subnet claim to autopopulate ownership information in an asset management database. As illustrated, a user device 202 may manage assets 204 on a test network 206 of a telecommunications network operator. An IP address assignment system 208 and asset management system 210 may also be part of the test network 206 or connected to/through the test network 206. At 212, a user of the user device 202 may claim ownership of a subnet of IP addresses at the IP address assignment system 208, and at 214, the IP address assignment system 208 may assign IP addresses to assets 204 based on the claimed subnets. At 216, the, the asset management system 210 may utilize knowledge of the associations between subnets and asset owners to automatically populate asset owners for assets 204 based on their assigned IP addresses.

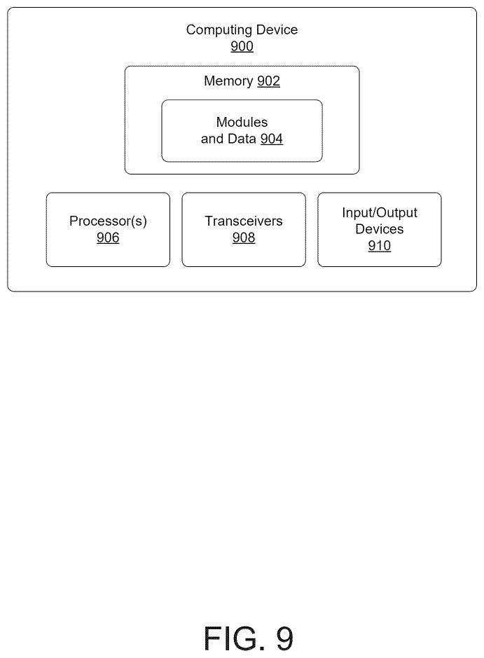

In various implementations, the user device 202 may be any sort of computing device or UE. Though depicted in FIG. 2 as a terminal, the user device 202 may be a server device, a personal computer (PC), a laptop computer, a tablet computer, a cellular phone, etc. The user device 202 may be a part of the test network 206 or may simply be connected through a gateway device of the test network 206. The assets 204 may also be any sort of computing device, such as any of the sorts of computing devices listed herein for user device 202. Further, assets 204 may be of a variety of device types; some assets 204 could be server devices, other PCs, others UEs, etc. Each of the IP address assignment system 208 and asset management system 210 may also be any sort of computing device, such as any of the sorts of computing devices listed herein for user device 202. Each of the IP address assignment system 208 and asset management system 210 may be of a different device type from the other or a same type. Either or both of the IP address assignment system 208 or asset management system 210 may part of the test network 206 or external to it and accessed through a gateway device of the test network 206. Further, while each of user device 202, assets 204, IP address assignment system 208, and asset management system 210 may be one or more physical devices, some or all of them may instead be logical devices (i.e., virtual machines) implemented on physical devices. An example computing device capable of implementing any one or more of the user device 202, assets 204, IP address assignment system 208, and asset management system 210 is illustrated in FIG. 9 and described below in greater detail with reference to that figure.

In some implementations, the test network 206 may be a laboratory or testing network of a telecommunications network operator used by the operator to test devices and services before their deployment on a “production” or customer-facing telecommunications network. As such, it may be a private or closed network, or a network which may have the capability to be a public or a private network. It may include wired connections (e.g., Ethernet cables, fiber-optic cables, etc.) and/or wireless connections (e.g., licensed or unlicensed radio frequency, etc.). The test network 206 may also include core network devices, access network devices, etc. In some examples, different parts of the network may be associated with different services or groups of services (e.g., emergency services, location services, etc.), and these services/service groups may be associated with an asset owner. Alternatively or additionally, an asset owner may simply be a person responsible for some subset of the assets 204, ensuring their compliance/security.

The IP address assignment system 208 may manage a block of IP addresses for the test network 206 or for multiple networks. As such, assets 204 of the test network 206 receive their IP addresses from the IP address assignment system 208. The IP addresses may be assigned in accordance with a configuration of the IP address assignment system 208. In some examples, that configuration may reflect claims of subnet ownership by asset owners. An owner of emergency services, for instance, could claim a specific subnet of IP addresses, and when an asset 204 associated with emergency services contacts the IP address assignment system 208 for its IP address, it is assigned an IP address from the claimed subnet.

To facilitate ownership claims, the IP address assignment system 208 may have an interface or application programming interface (API) enabling an asset owner or person acting on behalf of the asset owner to utilize the user device 202 to claim the subnet of IP addresses. Such an interface may be a simple graphic user interface (GUI) or an API that accepts commands from, e.g., a command shell interface at the user device 202. The size of the subnet claimed or number of subnets claimed may vary based on the needs of the asset owner.

In various implementations, with the assets having IP addresses assigned based on subnet claims, the asset management system 210 may federate information from the assets 204 or from other databases to build an asset database. That information federated from other sources may include identifiers of the assets 204, IP addresses of the asset 204, etc. The federated information may also include asset ownership. Alternatively or additionally, the asset management system 210 may automatically populate asset ownership for each asset 204 based on the subnet associated with the IP address of that asset 204. Configuration mapping asset owners to subnets may be received from the user device 202, from the IP address assignment system 208, or from another source. An outcome of the federating and automatic population of ownership may be an asset database which includes an asset owner from each asset 204 listed in the database.

In some implementations, an asset 204 may have multiple IP addresses from multiple subnets and may have multiple asset owners. In such implementations, the asset management system 210 may be configured to notify all asset owners of an asset 204 of any security or compliance issues, or to notify only a single asset owner or subset (e.g., if a problem is specific to fewer than all of the IP addresses of an asset 204).

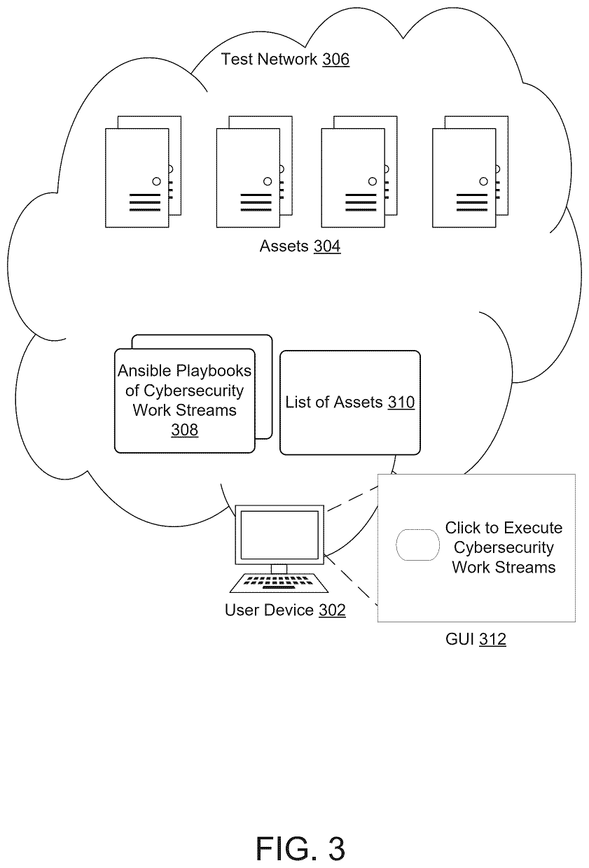

FIG. 3 is a network architecture diagram showing a subset of components involved in defining a list of cybersecurity work streams for specified telecommunications network assets and, responsive to a single user input, deploying the list of cybersecurity work streams. As illustrated, a user device 302 may manage assets 304 on a test network 306 of a telecommunications network operator. The user device 302 may define or retrieve one or more Ansible playbooks (or other type of lists of commands) 308 and a list of assets 310. Through a single input—made, e.g., through a GUI 312 of the user device 302—the playbooks 308 may be deployed to assets 304 listed in the list of assets 310. Each playbook 308 may include commands for one or more cybersecurity work streams to be performed at the assets 304 following deployment.

In various implementations, the user device 302 may be an example of user device 202 or may be a different device, of a same or different device type. The assets 304 may be examples of assets 204 or may be different devices of same and/or different device types. The test network 306 may be an example of the test network 206 or may be a different network of a same or different network type. An example computing device capable of implementing any one or more of the user device 302 and assets 304 is illustrated in FIG. 9 and described below in greater detail with reference to that figure.

The playbook(s) 308 may be Ansible playbooks, defined in the Python programming language and comprising commands associated with cybersecurity work streams. Some examples of cybersecurity work streams may include asset discovery, vulnerability scanning, endpoint detection and prevention tool installation, micro-segmentation, access control, etc. Such cybersecurity work streams may be associated with multiple applications. The playbook(s) 308 may be retrieved by the user device 302 from another system or from memory of the user device 302. The playbook(s) 308 may also or instead be defined by user device 302 based on input from a user of the user device 302.

The user device 302 may also retrieve or define a list of assets 310, which may include domain names, IP addresses, or both for the assets 304 that are to receive deployment of the cybersecurity work streams specified by the playbook(s) 308. The list of assets 310 may also be retrieved by the user device 302 from another system or from memory of the user device 302 or defined by user device 302 based on input from a user of the user device 302.

To enable defining or retrieval of the playbook(s) 308 and/or list of assets 310, the user device 302 may include logic that performs/enables those operations. In some examples, that logic also enables and receives, from input devices of the user device 302, a single input of a user of the user device 302. For example, the logic may specify the GUI 312, which may include a clickable button. Alternatively, the single input may be a touch input, a biometric input, a voice input, a camera input (e.g., Face ID), etc. The logic of the user device 302, receiving such an input, may deploy the cybersecurity work streams from the playbook(s) 308 to the assets 304.

In some implementations, the logic of the user device 302 may also enable the user to edit or make playbook(s) 308 and the list of assets 310. The logic may provide a GUI for defining the playbook(s) 308 and the list of assets 310 or other mechanism for specifying one or both of the playbook(s) 308 and the list of assets 310. Examples of editing include changing an order of commands in a playbook 308 such that cybersecurity work streams are deployed/executed in a different order.

In further examples, the user device 302 or other component (e.g., of the test network 306) may utilize machine learning to improve the playbook(s) 308 or list of assets 310. For example, if one order of commands in a playbook 308 results in failed execution of cybersecurity work streams and another, different order of the commands results in success, the machine learning logic may automatically use (or notify a user that the user should use) the more successful order of commands.

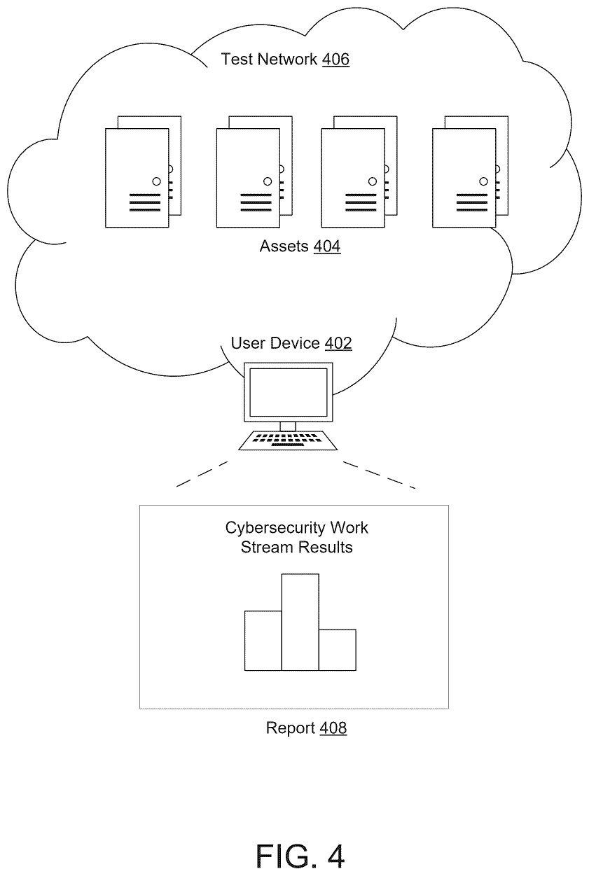

FIG. 4 is a network architecture diagram showing a subset of components involved in retrieving status information from telecommunications network assets for cybersecurity work streams, determining asset owners for the telecommunications network assets, and providing a report of cybersecurity work stream results to the asset owners or supervisors of asset owners. As illustrated, a user device 402 may manage assets 404 on a test network 406 of a telecommunications network operator. The user device 402 may also receive or retrieve results of cybersecurity work streams and provide a report 408 providing those results.

In various implementations, the user device 402 may be an example of user device 202, 302, or may be a different device, of a same or different device type. The assets 404 may be examples of assets 204, 304, or may be different devices of same and/or different device types. The test network 406 may be an example of the test network 206, 306, or may be a different network of a same or different network type. An example computing device capable of implementing any one or more of the user device 402 and assets 404 is illustrated in FIG. 9 and described below in greater detail with reference to that figure.

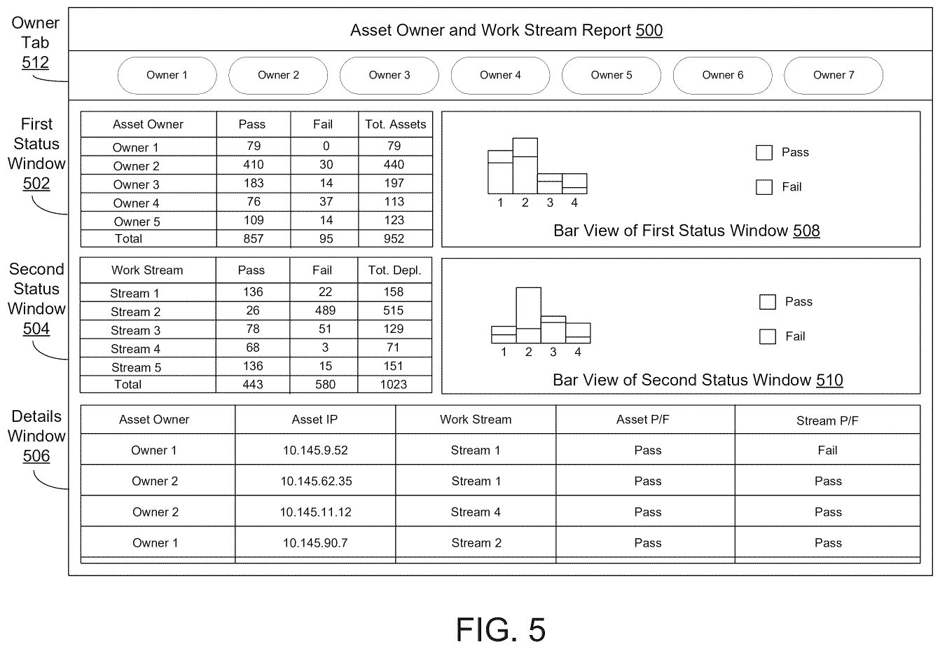

An example of report 408 is illustrated in FIG. 5. FIG. 5 is an example graphic user interface for a report of asset performance and cybersecurity work stream performance for asset owners and their supervisors. As shown, the report can include a header section 500, a first status window 502, a second status window 504, a details window 506, a bar chart view 508 of the first status window, a bar chart view 510 of the second status window, and asset owner tabs 512.

The first status window 502 may include a column listing asset owners, a column listing a corresponding number of assets that pass/meet a standard (e.g., assets that are reachable), a column listing a corresponding number of assets that fail/do not meet the standard (e.g., are not reachable), and a column listing a corresponding total number of assets. Each row of the first status window 502, then, includes an asset owner identifier, a number of assets for that asset owner that pass, a number of assets for that asset owner that fail, and a total number of assets for that asset owner. This same information can be shown in a bar chart in the bar chart view 508.

The second status window 504 may include a column listing cybersecurity work streams (or applications that correspond to them), a column listing a corresponding number of assets that pass/meet a standard (e.g., assets that are enabled for the work stream), a column listing a corresponding number of assets that fail/do not meet the standard (e.g., are not enabled for the work stream), and a column listing a corresponding total number of assets. Each row of the second status window 504, then, includes a cybersecurity work stream identifier, a number of assets for that work stream that pass, a number of assets for that work stream that fail, and a total number of assets for that work stream. This same information can be shown in a bar chart in the bar chart view 510.

Further, each combination of an asset owner and work stream may be shown in a row of the details window 506. The details window 506 may include a column for asset owner identifiers, a column for IP addresses of assets, a column for cybersecurity work stream identifiers, a column for pass/fail indications for their rows'combination of asset owner and asset IP address, and a column for pass/fail indications for their rows'combination of asset IP address and cybersecurity work stream identifier.

Additionally, as a report 408 may be provided to a supervisor of multiple asset owners, the report 408 may include asset owner tabs 512 to enable the report recipient to select a single asset owner or subset of asset owners to see results for.

Returning to FIG. 4, the report 408 can also be modified to add cybersecurity work streams or remove them (either simply from the report, or from playbook(s) 308). The report 408 may include feature(s) enabling this functionality (not shown). Such additional features could also involve adding/removing entire playbook(s) 308, suggesting playbook(s) 308 or individual work streams, etc.

FIGS. 6-8 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 6 is a flow diagram of an illustrative process for receiving information for an asset, the information including an Internet protocol (IP) address of the asset, updating the asset database based on the information for the asset, and, based on a subnet associated with the IP address, automatically populating an asset owner for the asset in the asset database. As illustrated at 602, one or more computing devices implementing an asset database for a network (e.g., test network of a telecommunications network operator) may enable an asset owner to claim ownership of a subnet of IP addresses at an IP address assignment system. At 604, claiming ownership of the subnet may include requesting a group of IP addresses for use by a group of assets, with the IP address assignment system making an allocation of the subnet based on the requesting and assigning IP addresses from the subnet to assets.

At 606, the one or more computing devices receive information for an asset, the information including an IP address of the asset.

At 608, the one or more computing devices update the asset database based on the information for the asset.

At 610, based on the subnet associated with the IP address, the one or more computing devices automatically populate an asset owner for the asset in the asset database. Configuration information available to the one or more computing devices associates the subnet with the asset owner.

At 612, the one or more computing devices may perform a security scan of asset(s) for the network and utilize the asset database to identify asset owner(s) for asset(s) experiencing security issue(s).

At 614, the one or more computing devices may perform a compliance scan of asset(s) for the network and utilize the asset database to identify asset owner(s) for asset(s) failing to comply with requirements.

In some implementations, the asset may have a plurality of IP addresses and a corresponding plurality of asset owners automatically populated in the asset database. At 616, the one or more computing devices may notify a first asset owner of the plurality of asset owners but not second asset owner(s) of the plurality of asset owners of an issue associated with an IP address corresponding to the first asset owner.

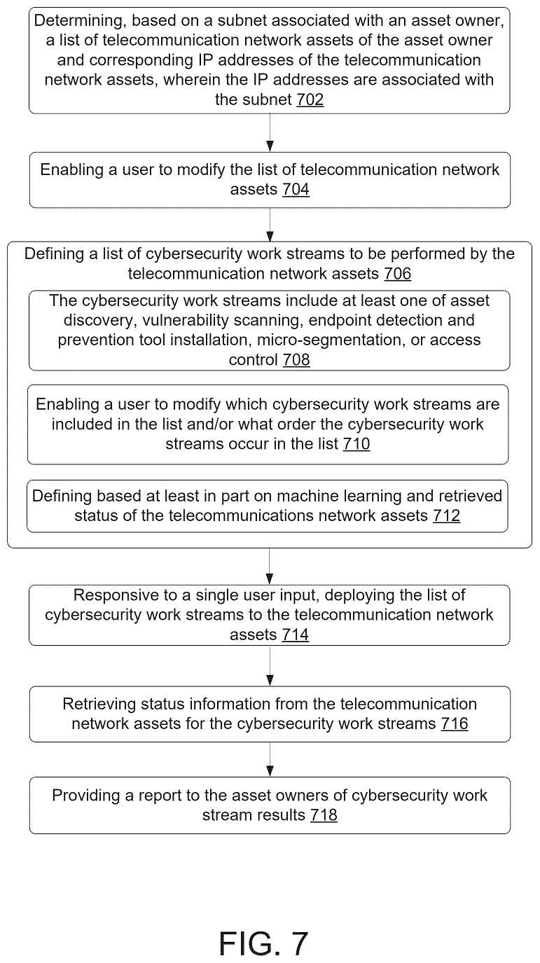

FIG. 7 is a flow diagram of an illustrative process for defining a list of cybersecurity work streams for specified telecommunications network assets and, responsive to a single user input, deploying the list of cybersecurity work streams. As illustrated at 702, one or more computing devices determine, based on a subnet associated with an asset owner, a list of telecommunications network assets of the asset owner and corresponding IP addresses of the telecommunications network assets. In such implementations, the IP addresses are associated with the subnet.

At 704, the one or more computing devices may enable a user (e.g., the asset owner) to modify the list of telecommunications network assets.

At 706, the one or more computing devices define a list of cybersecurity work streams to be performed by the telecommunications network assets. The list of cybersecurity work streams may be an Ansible playbook. At 708, the cybersecurity work streams may include at least one of asset discovery, vulnerability scanning, endpoint detection and prevention tool installation, micro-segmentation, or access control. At 710, the defining may include enabling a user to modify which cybersecurity work streams are included in the list and/or what order the cybersecurity work streams occur in the list. At 712, the defining may be based at least in part on machine learning and retrieved status of the telecommunications network assets.

At 714, responsive to a single user input, the one or more computing devices deploy the list of cybersecurity work streams to the telecommunications network assets.

At 716, the one or more computing devices may retrieve status information from the telecommunications network assets for the cybersecurity work streams and, at 718, may provide a report to the asset owners of cybersecurity work stream results.

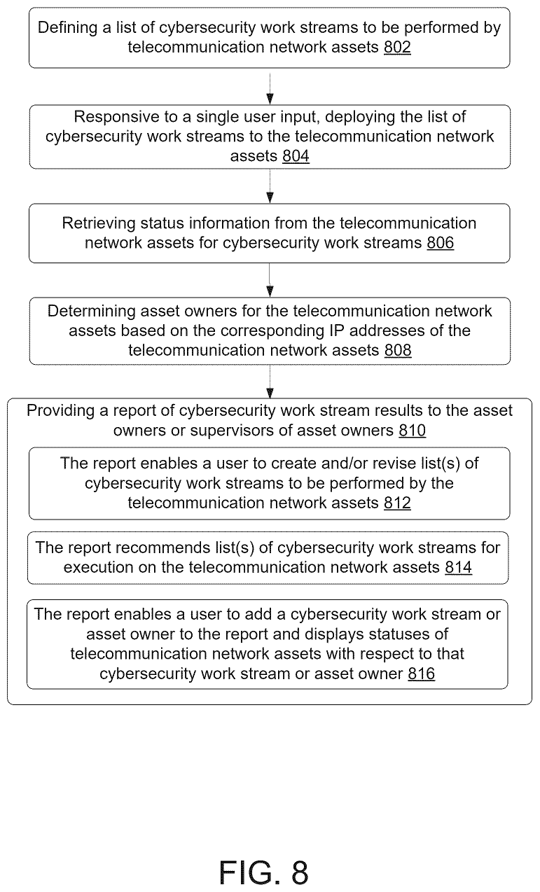

FIG. 8 is a flow diagram of an illustrative process for retrieving status information from telecommunications network assets for cybersecurity work streams, determining asset owners for the telecommunications network assets, and providing a report of cybersecurity work stream results to the asset owners or supervisors of asset owners. As illustrated at 802, one or more computing devices may define a list of cybersecurity work streams to be performed by the telecommunications network assets. At 804, responsive to a single user input, the one or more computing devices may then deploy the list of cybersecurity work streams to the telecommunications network assets.

At 806, the one or more computing devices retrieve status information from telecommunications network assets for cybersecurity work streams.

At 808, the one or more computing devices determine asset owners for the telecommunications network assets based on the corresponding IP addresses of the telecommunications network assets. In such implementations, each asset owner is associated with a subnet, and each IP address is associated with a subnet.

At 810, the one or more computing devices provide a report of cybersecurity work stream results to the asset owners or supervisors of asset owners. At 812, the report enables a user to create and/or revise list(s) of cybersecurity work streams to be performed by the telecommunications network assets. At 814, the report recommends list(s) of cybersecurity work streams for execution on the telecommunications network assets. At 816, the report enables a user to add a cybersecurity work stream or asset owner to the report and displays statuses of telecommunications network assets with respect to that cybersecurity work stream or asset owner. In some implementations, the report includes at least one of:
a status window listing asset owners and, for each asset owner, a count of

telecommunications network assets meeting a standard and a count of telecommunications network assets not meeting a standard;
a status window listing cybersecurity work streams and, for each cybersecurity work

stream, a count of telecommunications network assets meeting a standard and a count of telecommunications network assets not meeting a standard; or
a details window listing each combination of an asset owner and cybersecurity work

stream and, for each combination, an indication of whether or not the combination is meeting a standard.

FIG. 9 is a schematic diagram of a computing device capable of implementing functionality of at least one of the components illustrated in FIGS. 2-4. As shown, the computing device 900 includes a memory 902 storing modules and data 904, processor(s) 906, transceivers 908, and input/output devices 910.

In various examples, the memory 902 can include system memory, which may be volatile (such as RAM), non-volatile (such as ROM, flash memory, etc.) or some combination of the two. The memory 902 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 902 can include one or more software or firmware elements, such as computer-readable instructions that are executable by the one or more processors 906. For example, the memory 902 can store computer-executable instructions associated with modules and data 904. The modules and data 904 can include a platform, operating system, and applications, and data utilized by the platform, operating system, and applications. Further, the modules and data 904 can implement any of the functionality for the devices and components described and illustrated herein.

In various examples, the processor(s) 906 can be a central processing unit (CPU), a graphics processing unit (GPU), or both CPU and GPU, or any other type of processing unit. Each of the one or more processor(s) 906 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 906 may also be responsible for executing all computer applications stored in the memory 902, which can be associated with types of volatile (RAM) and/or nonvolatile (ROM) memory.

The transceivers 908 can include modems, interfaces, antennas, Ethernet ports, cable interface components, and/or other components that perform or assist in exchanging wireless communications, wired communications, or both.

While the computing device need not include input/output devices 910, in some implementations it may include one, some, or all of these. For example, the input/output devices 910 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 910 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 910 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as Fifth Generation (5G)/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A system comprising:
one or more processors; and
programming instructions configured to be executed by the one or more processors to perform operations including:
retrieving a list of telecommunications network assets and corresponding Internet protocol (IP) addresses of the telecommunications network assets;
defining a list of cybersecurity work streams to be performed by the telecommunications network assets;
responsive to a single user input, deploying the list of cybersecurity work streams to the subset of telecommunications network assets;
retrieving status from telecommunications network assets for the cybersecurity work streams;
determining asset owners for the telecommunications network assets based on the corresponding IP addresses of the telecommunications network assets, wherein each asset owner is associated with a subnet and each IP address is associated with a subnet; and
providing a report to the asset owners of cybersecurity work stream results.

2. The system of claim 1, wherein the list of cybersecurity work streams is an Ansible playbook.

3. The system of claim 1, wherein the cybersecurity work streams include at least one of asset discovery, vulnerability scanning, endpoint detection and prevention tool installation, micro-segmentation, or access control.

4. The system of claim 1, wherein the defining includes enabling a user to modify which cybersecurity work streams are included in the list and/or what order the cybersecurity work streams occur in the list.

5. The system of claim 1, wherein the defining is based at least in part on machine learning and retrieved status of the telecommunications network assets.

6. The system of claim 1, wherein the report enables a user to create and/or revise list(s) of cybersecurity work streams.

7. The system of claim 1, wherein the report recommends list(s) of cybersecurity work streams for execution on the telecommunications network assets.

8. A method comprising:
determining, by a computing device and based on a subnet associated with an asset owner, a list of telecommunications network assets of the asset owner and corresponding Internet protocol (IP) addresses of the telecommunications network assets, wherein the IP addresses are associated with the subnet;
defining, by the computing device, a list of cybersecurity work streams to be performed by the telecommunications network assets; and
responsive to a single user input, deploying the list of cybersecurity work streams to the telecommunications network assets.

9. The method of claim 1, wherein the list of cybersecurity work streams is an Ansible playbook.

10. The method of claim 1, wherein the cybersecurity work streams include at least one of asset discovery, vulnerability scanning, endpoint detection and prevention tool installation, micro-segmentation, or access control.

11. The method of claim 1, wherein the defining includes enabling a user to modify which cybersecurity work streams are included in the list and/or what order the cybersecurity work streams occur in the list.

12. The method of claim 1, wherein the defining is based at least in part on machine learning and retrieved status of the telecommunications network assets.

13. The method of claim 1, further comprising enabling a user to modify the list of telecommunications network assets.

14. The method of claim 1, further comprising:
retrieving status information from the telecommunications network assets for the cybersecurity work streams; and
providing a report to the asset owners of cybersecurity work stream results.

15. A non-transitory computer storage medium having programming instructions stored thereon that, when operated by a computing device implementing an asset database for a network, cause the computing device to perform operations comprising:
retrieving status information from telecommunications network assets for cybersecurity work streams;
determining asset owners for the telecommunications network assets based on the corresponding IP addresses of the telecommunications network assets, wherein each asset owner is associated with a subnet and each IP address is associated with a subnet; and
providing a report of cybersecurity work stream results to the asset owners or supervisors of asset owners.

16. The non-transitory computer storage medium of claim 15, wherein the report includes at least one of:
a status window listing asset owners and, for each asset owner, a count of telecommunications network assets meeting a standard and a count of telecommunications network assets not meeting a standard;
a status window listing cybersecurity work streams and, for each cybersecurity work stream, a count of telecommunications network assets meeting a standard and a count of telecommunications network assets not meeting a standard; or
a details window listing each combination of an asset owner and cybersecurity work stream and, for each combination, an indication of whether or not the combination is meeting a standard.

17. The non-transitory computer storage medium of claim 15, wherein the report enables a user to create and/or revise list(s) of cybersecurity work streams to be performed by the telecommunications network assets.

18. The non-transitory computer storage medium of claim 15, wherein the report recommends list(s) of cybersecurity work streams for execution on the telecommunications network assets.

19. The non-transitory computer storage medium of claim 15, wherein the report enables a user to add a cybersecurity work stream or asset owner to the report and displays statuses of telecommunications network assets with respect to that cybersecurity work stream or asset owner.

20. The non-transitory computer storage medium of claim 15, wherein the operations further comprise:
defining a list of cybersecurity work streams to be performed by the telecommunications network assets; and
responsive to a single user input, deploying the list of cybersecurity work streams to the telecommunications network assets.
